(19) United States
(12) Patent Application Publication
(10) Pub. No.: US 2026/0208543 A1
(43) Pub. Date: Jul. 23, 2026

(54) A TIRE CALIBRATION ARRANGEMENT FOR VEHICLE AXLES

(71) Applicant: COLVEN, SA, Santa Fe (AR)

(72) Inventors: Primo Antonio Colussi, Santa Fe (AR); Natalio Domingo Venica, Santa Fe (AR)

(21) Appl. No.: 19/137,729

(22) PCT Filed: Dec. 12, 2023
(86) PCT No.: PCT/EP2023/085261

§ 371 Date: Jun. 11, 2025

(30) Foreign Application Priority Data
Dec. 13, 2022 (AR) P20220103404

(51) Int. Cl. B60C 23/00

(52) U.S. Cl. CPC B60C 23/00363; B60C 23/00345; B60C 23/00381

(57) ABSTRACT

A tire calibration arrangement for vehicle axles, either steering axles or fixed axles, that stands out due to the fact that it is used in steering or fixed axles and which components are provided within them, which is entirely novel since the elements in conventional systems are placed out of the axle due to design inconveniences.

### FIELD OF THE INVENTION

This invention is directed to pressure control, regulation and calibration equipment in a tire pressure arrangement, preferably for tire calibration and, more particularly, this invention relates to a tire calibration arrangement placed within a vehicle axle, either a fixed or steering axle, which is entirely novel since conventional systems are arranged and developed out of the axle due to design constraints.

### PRIOR ART DESCRIPTION

At present, there exist numerous arrangements designed for the maintenance, reduction or increase of the tire pressure, either in motion or at rest, which are commonly named central tire inflation-deflation systems. The application thereof may be in a wide variety of vehicles. The vehicles most commonly equipped with this kind of systems are heavy vehicles of passenger or cargo transport such as short, medium and long distance buses, trucks, cargo transport trailers, etc.

Tire inflation-deflation systems usually comprise an outer air compressor or tank connected by means of respective pipes and tubes to tire inflation valves, and, in turn, there exist control equipment, sensors or means that detect the pressure lack or excess within the tires and send the corresponding signals to compensate the pressure within them. It is to be noted that inflation or deflation systems such as those described in Argentine Patent AR037242 are well known in the field of the art and, consequently, they shall not be further described herein.

Likewise, the axles of cargo or transport vehicles equipped with these systems may be hollow with axle ends commonly having a through-hole. The hollow axle provides an advantageous duct to supply air pressure to the wheel end through respective pipes. Between the axles and the tires or wheels, there are valves that allow for inflation or deflation (AR Patent AR037242) and before them, there are rotary couplings to be mounted on the vehicle wheels.

Said rotary couplings may be those couplings disclosed in the Argentine Patent Application P20210103605 of the same owner and herein incorporated by reference. According to FIG. 1 related to the prior art and, more particularly, to FIG. 4 of Patent Application P20210103605, a rotor 101 is mounted on a hollow axle end 102 in which there is a hub 103 for mounting a tire 104. The rotor 101 is mounted on said hub 103 by means of a rotary support 105 and comprises a block 106 rotatably mounted on an axle 107 that has an inner air passage or duct 108 in communication by means of an inner end and, more particularly, a connector 109, with a pressurized air hose or pipe 110 located within said hollow axle 102 and which carries the pressurized air from an outer air reservoir or tank.

On the other hand, said block 106 comprises an inner part 111 and an outer part 112. The inner part 111 is rotatably mounted on said axle 107 by means of a bearing 113, while the outer part 112 comprises a transfer chamber 114 in communication with an outer end of said inner air passage 108 of the axle 107, so that air is ejected through said transfer chamber 114 to respective inflation or deflation valves (Patent AR AR037242) through corresponding pipes 115 (not shown) to generate the tire inflation and/or deflation.

As it may be seen, tire calibration systems are well known in the field of the art. However, these systems provided within axles, such as axle 102 of Patent Application P20210103605 or Patent AR 17729155, are systems for fixed or rear axles of a vehicle such as a bus or coupling. At present, there does not exist in the field of the art any tire calibration system arranged within front steering axles due to their design constraints and to the fact that they are in constant motion. Therefore, the currently known tire calibration systems of conventional front steering axles are externally arranged.

The known systems do not provide calibration devices having flexible and telescopic connections that allow for a tight stationary connection with radial closure at any point along its entire length while keeping their functionality despite any misalignment and allowing to interchange rotors among axles.

By virtue of the current state of the art related to the tire inflation and/or deflation system, it would be very convenient to have a new calibration arrangement that may be arranged within fixed and/or steering axles to provide a suitable tire calibration besides reducing the possibilities of impact when the vehicles are stopped or in motion.

### BRIEF DESCRIPTION OF THE INVENTION

It is therefore an object of this invention to provide a new tire calibration arrangement of vehicle axles which construction elements are provided within said axles, which is completely novel in the field of the art.

It is a further object of this invention to provide a calibration arrangement provided with a flexible telescopic connector and a rotor that allows for its tight stationary connection with radial closure at any point along its entire length, thus keeping its functionality despite any kind of misalignment as well as the interchangeability of rotors among axles.

It is still another object of this invention to provide a tire calibration arrangement having a main connector connected to said flexible hollow telescopic connector in order to provide pressurized air from a source or compressor to a rotor arranged in a hub.

It is still a further object of this invention to provide a tire calibration arrangement for vehicle axles of the type having a rotor operatively connected to a pressurized air source and, in turn, to a corresponding inflation and/or deflation valve provided in the tire in order to keep the suitable pressure therein, wherein there is a flexible hollow telescopic connector having a first end on which said rotor is mounted and a second end held within a main hollow connector; wherein said main hollow connector is connected to an end of a pressurized air hose or pipe projected into and along an inner duct of the corresponding end of said steering axle in order to communicate said pressurized air source with said rotor.

### BRIEF DESCRIPTION OF THE DRAWINGS

For the purpose of providing more clarity and a better understanding of the subject-matter of this invention, it has been illustrated in several figures, in which the invention has been represented by way of example in one of the preferred embodiments thereof, wherein:

FIG. 1 is a section view of a rotary coupling for rear or fixed axles according to the prior art;

FIG. 2 is a perspective view of a vehicle steering end, which is provided within the tire calibration arrangement of this invention;

FIG. 3 is a perspective and section view of FIG. 2 according to this invention;

FIG. 4 is a top section view of FIG. 2 according to this invention;

FIG. 5 is a section view of an end of a steering axle wherein the calibration arrangement is provided according to this invention;

FIG. 6 is an enlarged section view wherein the arrangement according to this invention may be seen;

FIG. 7 is a section view of the calibration arrangement according to this invention, wherein the axle end may be the end of a fixed or steering axle;

FIG. 8 is an enlarged view of a portion of the calibration arrangement for steering axles according to this invention; and

FIG. 9 is a side partial section view of the calibration arrangement of the invention in which another type of rotor is shown.

### DETAILED DESCRIPTION OF THE INVENTION

With reference now to the figures, it may be seen that this invention relates to a new tire calibration arrangement that stands out for the fact that it is used in axle ends, whether fixed or steering axles, and which components are arranged within the axles, which is completely novel since conventional systems arrange their components out of the axle due to design constraints.

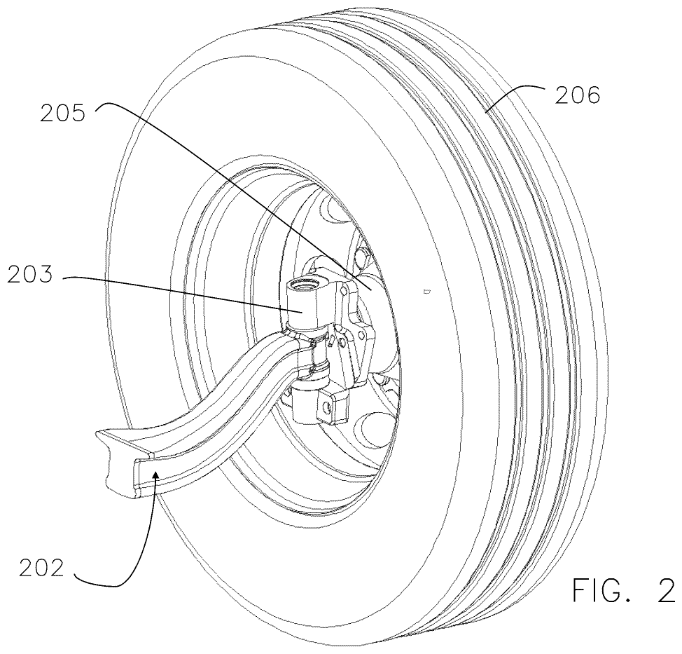

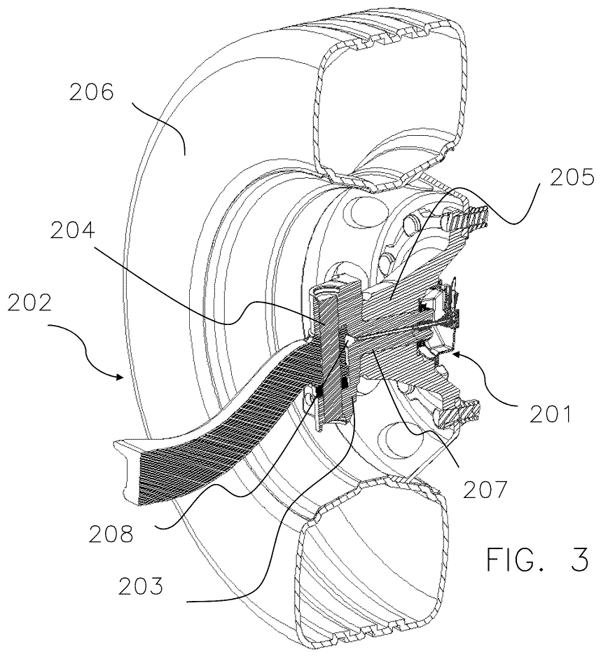

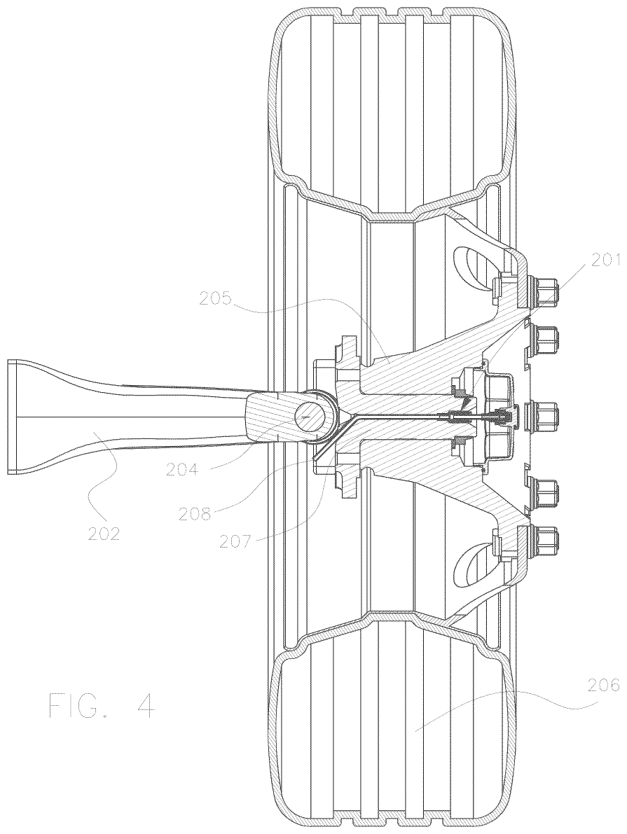

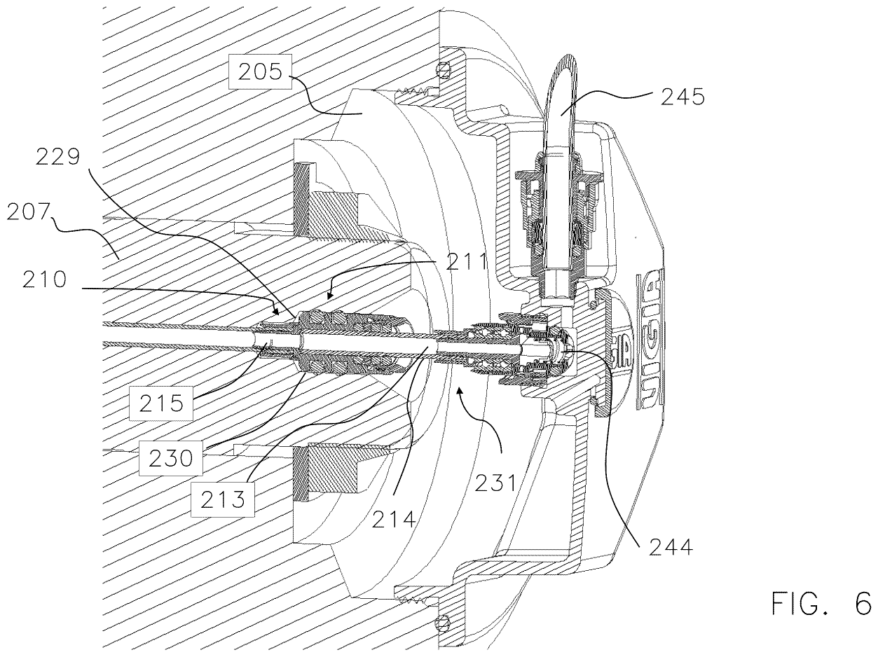

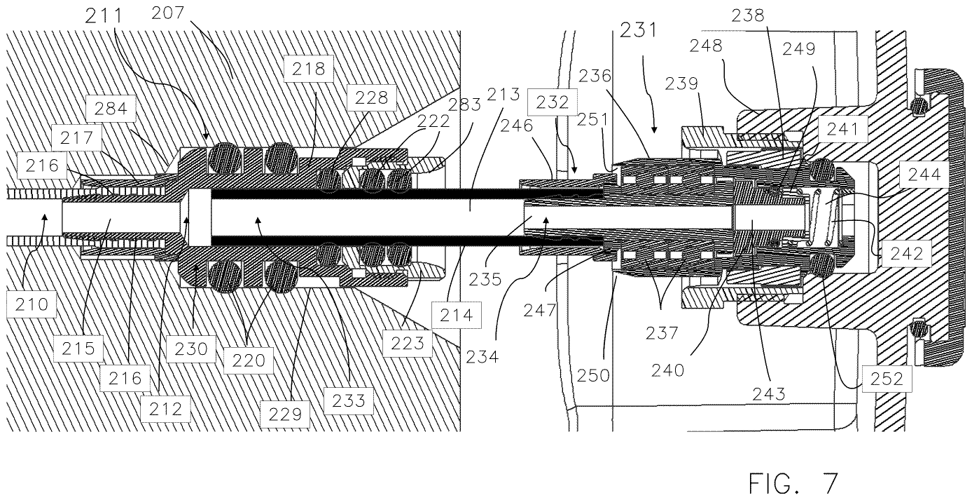

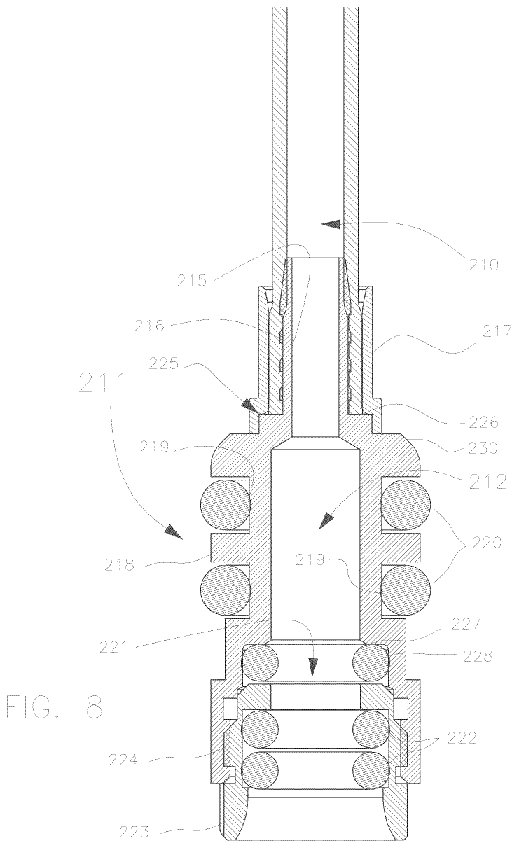

Therefore, and according to FIGS. 2 to 8, the calibration arrangement of this invention is indicated by means of the general reference 201 and it is used for vehicle axles, whether fixed or steering axles, as mentioned hereinabove, but said feature is not limitative for this invention since said arrangement may be adapted and used in conventional fixed axles with one or more tires. According to FIGS. 2 to 4, said steering axle comprises a steering end 202 connected to a hub housing 203 by means of a kingbolt 204, and mounted on said hub housing 203 there is a hub 205 on which a tire 206 and a rotor 231 shall be mounted, and said rotor 231 shall be described below.

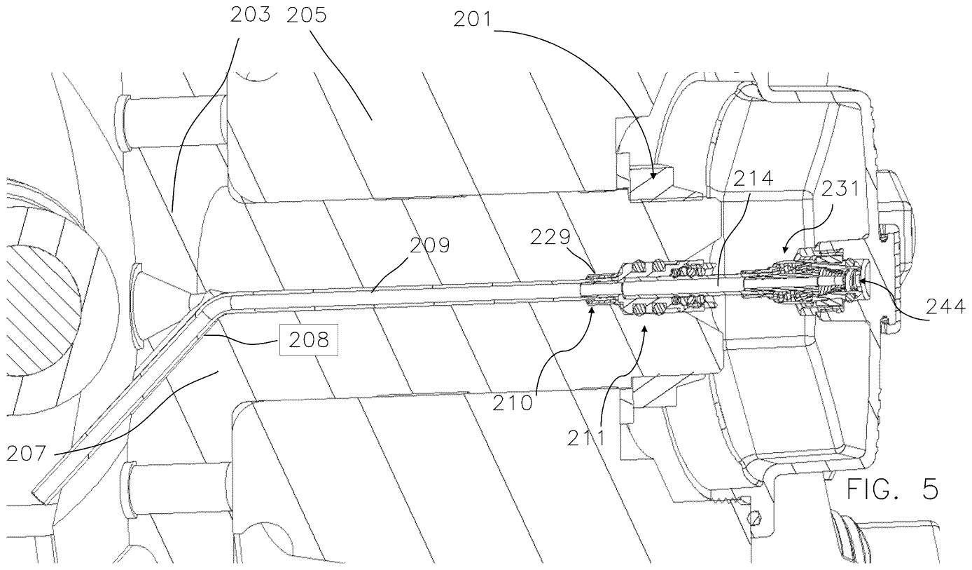

According to FIG. 5, the hub housing 203 comprises a hollow axle 207 having an inner passage 208 through which at least a pressurized air hose or pipe 209 is projected and extended along said passage and connected to a pressurized air source (not illustrated). Likewise, said pressurized air hose or pipe 209 is connected through an end 210 to a main hollow connector 211.

According to FIGS. 5 to 8, the main hollow connector 211 comprises a variable section inner passage or duct 212 in communication with said pressurized air hose or pipe 209 and, in turn, with an inner passage 213 of a flexible hollow telescopic connector 214. Likewise, said main hollow connector 211 has a connection end 215 provided with a plurality of sawteeth 216 that fit tightly in the end 210 of said pressurized air hose or pipe 209, wherein the latter is tightly held due to the deformation of this end 210 of the hose 209 in the sawteeth 216 and the adjustment provided by an outer coupling 217. Said main connector 211 further comprises a main body 218 having a plurality of outer radial grooves 219 wherein corresponding outer O-ring seals 220 are arranged and by means of the adjustment thereof the longitudinal and rotary movement of the main hollow connector 211 is restricted.

On the other hand, the main hollow connector 211 has an inner housing 221 through which an end portion of said flexible hollow telescopic connector 214 passes and said flexible hollow telescopic connector is longitudinally and rotatably held within the main connector 211 by means of inner O-ring seals 222 provided within an adjusting nut for telescopic connector 223 mounted within said inner housing 221 by means of a thread 224. It is to be mentioned that the adjusting nut has a channeling surface 283 that helps to correct the direction or runout of the connector 214 when it is mounted in the main connector 211. Furthermore, the seals 222 correct a possible minor scale runout of the connector 214 to ensure in this way that the arrangement shall make it possible to comply with its functionality.

It is highlighted that between said connection end 215 and said main body 218 of the main hollow connector 211, a shoulder or step 225 is defined, on which the end 210 of said pressurized air pipe or hose 209 is supported and said shoulder or step 225 of the connector 211 is in turn tightly supported by a step 226 of said outer coupling 217. Likewise, between a seat 227 of said inner housing 221 of said main connector 211 and said adjusting nut for telescopic connector 223, an O-ring seal 228 is arranged and said O-ring 228 hovers over the flexible hollow telescopic connector 214 thus generating a tight closure between said adjusting nut for telescopic connector 223 and said flexible hollow connector 214. The seal 228 and the seals 222 are separately arranged by means of the adjusting nut for telescopic connector 223. This is due to the fact that the type of linkage and shape of the elements makes it possible to ensure the O-rings integrity in case of possible overpressures in the hub, that is to say that it prevents their deterioration due to excessive crushing.

In this way, said main hollow connector 211 is arranged within an end housing 229 of said inner duct 208 of the end of said steering axle so that it is held in a fixed way by means of said outer O-ring seals 220 provided in the outer radial grooves 219 of the main hollow body 211 and of the linkage among the end 210 of the hose or pipe 209, the sawteeth 216 and the outer coupling 217. Wherein, said end housing 229 has a seat 284 on which said main hollow connector 211 is supported by means of a shoulder 230. Another property of the outer o-ring seals 220 is that they prevent any substance from entering or leaving by means of the inner air duct or passage 208.

With reference now again to the flexible hollow telescopic connector 214, it allows for its tight stationary connection with radial closure at any point along its entire length. In this way, its functionality is maintained despite any kind of misalignment existing among the elements. On the other hand, it allows for the interchangeability of rotors 231 among the axle tips due to its design. The inner passage 213 of the flexible hollow telescopic connector 214 thus allow for the operative communication between said pressurized air source (not illustrated) and said rotor 231 that shall convey the received pressurized air to a corresponding inflation and/or deflation valve (not illustrated) provided in the tire thus maintaining the suitable pressure therein. In turn, said flexible hollow telescopic connector 214 has an end 232 on which said rotor 231 is mounted and a second end 233 that is kept held within said main hollow connector 211 as described herein above.

Moreover, said rotor 231 is connected to said flexible hollow telescopic connector 214 through a rotor axle 234 which inner duct or passage 235 is in communication with the inner passage 213 of said flexible hollow telescopic connector 214 and, in turn, with the inner duct 212 of the main hollow connector 211 and the pressurized air hose or pipe 209 that is connected to said pressurized air source (not illustrated).

As an example, but without limitation for this invention since any type of rotor may be considered and used according to the conveniences of the circumstances, said rotor 231 further comprises a block 236 rotatably mounted on said rotor axle 234 by means of respective ball bearings 237; a coupling 246 (similar outer coupling 217) within which said end 232 of said flexible hollow telescopic connector 214 is arranged, wherein said flexible hollow telescopic connector 214 is kept held among said connector 246, said rotor axle 234 and a locking washer 247; a hexagonal anti-rotation ring 238 externally mounted on said block 236; an adjusting nut 239 integrally mounted on the cover of the axle tip or rotor coupling 248 that generates an axial fixation of the hexagonal anti-rotation ring 238 and, consequently, of the rotor 231, and this hexagonal anti-rotation ring 238 allows for certain runout in the rotor 231 functioning with regard to the main connector 211; and a solid seal 240 having an axle-seal sealing surface arranged in the interior of said block 236 and that is kept stationarily held by means of a set of a guide 241, a spring 242 and O-ring 249, said seal 240 is provided with an inner passage 243 in communication with the inner passage 235 of said rotor axle 234, and, in turn, said inner passage 243 of the solid seal 240 is in communication with a transfer chamber 244 that is in operative communication with said respective tire inflation and/or deflation valves through corresponding pipes 245. For this purpose, an outer O-ring 252 is provided and said O-ring makes it possible to maintain a tight closure between the outer surface of block 236 and the cover of the axle tip or rotor coupling 248 that serves as a rotor support 231 and air channeling to the pipes 245.

On the other hand, the solid seal 240 has on its surface a step formed by the solid seal 240 and the guide 241, wherein an O-ring 249 is provided, said O-ring makes it possible to tightly seal the transfer chamber 244 against other block cavities 236.

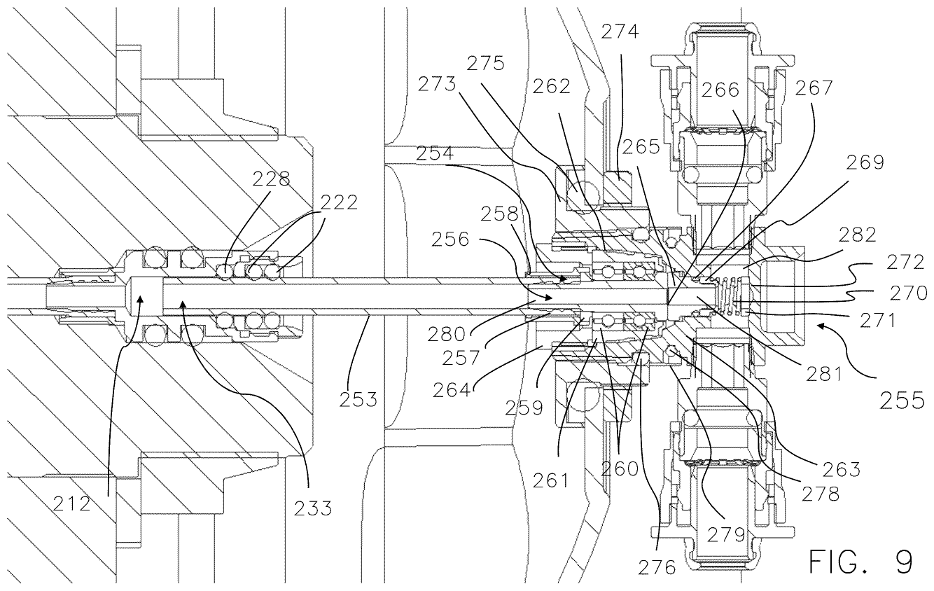

For the purpose of keeping all of the inner elements of the block 236 held in an axial and rotary way within it, there is the resource of folding the rotor surface 250, which gets in contact with the outer raceway 251 of one of the ball bearings 237 without hindering the correct operation thereof. On the other hand, this rotor is not the only one that may work with the main connector 211. In FIG. 9, the flexible hollow connector 253 (similar to element 214) may be seen, which generates a tight closure with the O-rings 222 and 228 of the main connector 211. On the other end 254 of said flexible hollow connector 253 a rotor 255 is mounted.

The rotor 255 is connected to the flexible hollow connector 253 through a rotor axle 256 (similar to 234). The connection is effective by means of the deformation of the end 254 with the section of the sawteeth 257 of the rotor axle 256 and an outer coupling 258 (similar to 217). The coupling 258 is fixed to the locking washer 259 by interference and the latter is fixed to the rotor axle 256.

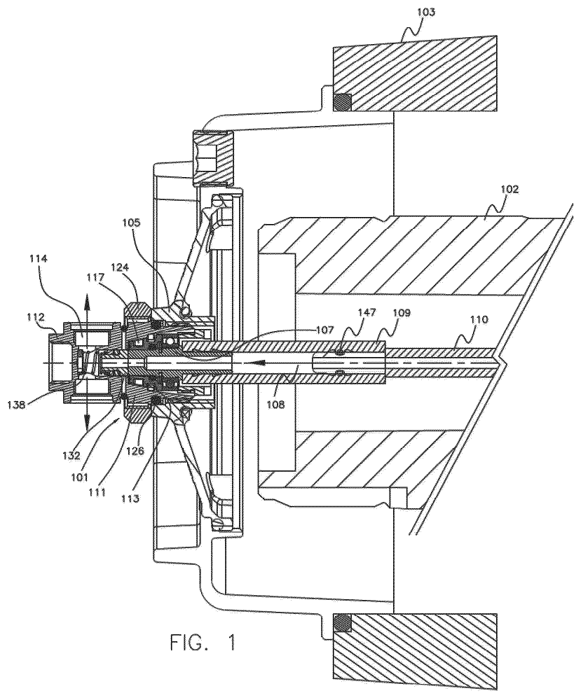

On the other hand, the locking washer 259 axially fixes the movement of the inner raceway of the ball bearings 260 mounted on the rotor axle 256. The ball bearings 260 are located within an oil trap or bearing 261 (with a similar function to this one in FIG. 1, element 117, Patent AR 17729155) attached to the inner surface 262 of the threaded rotor block 263.

In this way, there is a fixing nut 264 that is threaded in block 263 that axially fixes the oil trap or bearing 261, and, consequently, immobilizes the rotor axle 256 and ball bearings 260 that are joined by means of the locking washer 259.

The rotor axle 256 is in direct contact with the solid seal 265 thus generating a tight closure on the surface defined by the contact between them 266. The solid seal 265 has an O-ring 267 mounted on its external surface, which generates a tight closure against the surface 268 of the threaded telescopic rotor block 263. On the element 265, a guide 269 is mounted and said guide 269 serves as a housing and anti-rotation lock of spring 270. The rotatory fixation of this spring becomes effective with the implementation of an anti-rotation washer 271 fixed on the threaded telescopic rotor block 263 on surface 272.

The inner threaded telescopic rotor 255 is threaded and centered on the hollow axle 253 by means of the rotor coupling 273, which, in turn, is fixed on the hub 205 by means of a rotor coupling locknut 274 which joint is tight due to the implementation of the o-ring of the rotor coupling 275. The rotor generates a tight closure with the rotor coupling 273 by means of the O-ring 276 placed on an outer groove 277 of the rotor block 263 thus making it possible to isolate the interior of the hub from the outside. In case undesired overpressures are generated, the rotor block has a hole that communicates it from the hub interior to the exterior. The hole is covered by the O-ring 278 which generates certain stress that causes a minimum vent pressure of said inner pressure. In order that the tightness conditions of element 278 remain protected, a protection ring 279 is placed on the rotor block 263. In this way, the air from the feeding source (not illustrated) enters the pressurized air hose or pipe 209 in order to enter the main connector 211 and flow through the air duct or passage 280 of the rotor axle and the air passage 281 of the solid seal to the transfer chamber of the rotor block 282 and then be diverted to the inflation valves by means of outlets 283.

this way, the calibration arrangement of this invention is composed and constructed and it is designed to be used in steering axles, particularly within them, thus making it possible that by handling the rotor or the set f the rotor and the cover or rotor support, they are interchangeable among axles, which means that it is a complete novelty in the state of the art since the conventional systems of the prior art are arranged out of the steering axle due to design issues. This invention solves said design inconveniences by providing a calibration arrangement that may be adapted to any axle type, not only steerings axle but also fixed axles without any inconvenience.

1. A tire calibration arrangement for vehicle axles of the type having a rotor operatively connected to a pressurized air source and, in turn, to a corresponding inflation and/or deflation valve provided in the tire in order to maintain the suitable pressure therein, said arrangement characterized in that it comprises:
a flexible hollow telescopic connector having a first end where said rotor is mounted, and a second end that is kept held within a main hollow connector;
wherein said main hollow connector is connected to an end of a pressurized air hose or pipe that projects into and along an inner duct of the corresponding end of said steering axle in order to communicate said pressurized air source with said rotor.

2. The tire calibration arrangement according to claim 1, characterized in that said main hollow connector comprises:
a variable section inner passage or duct in communication with said pressurized air hose or pipe and, in turn, with an inner passage of said flexible hollow telescopic connector;
a connection end provided with a plurality of teeth that fit tightly in the end of said pressurized air hose or pipe, which, in turn, is kept held by means of an outer coupling and the same deformation of the hose;
a main body having a plurality of outer radial grooves where they are provided with corresponding outer O-ring seals that keep the main body of the hollow connector held in the axle;
an inner housing through which an end portion of said flexible hollow telescopic connector passes, where said flexible hollow telescopic connector is kept held within the main connector by means of inner O-ring seals provided in an adjusting nut for the telescopic connector mounted within said inner housing.

3. The tire calibration arrangement according to claim 2, characterized in that between said connection end and said main body of the hollow connector a shoulder or step is defined and on which the end of said pressurized air hose or pipe is supported, said shoulder or step of the connector is in turn supported on and tightly held by a step of said outer coupling.

4. The tire calibration arrangement according to claim 2, characterized in that between a seat of said inner housing of said main connector and said adjusting nut for telescopic connector, an O-ring seal that, in turn, keeps said telescopic hollow axle held is provided.

5. The tire calibration arrangement according to any of the preceding claims, characterized in that said main hollow connector is arranged within an end housing of said inner duct of the end of said steering axle, so that it is tightly fixed by means of said outer O-ring seals provided in the outer radial grooves of the main hollow body and said outer coupling.

6. The tire calibration arrangement according to claim 5, characterized in that said end housing has a seat on which said main hollow connector is supported.

7. The tire calibration arrangement according to any of the preceding claims, characterized in that said rotor is connected to said flexible hollow telescopic connector by means of a rotor axle which inner duct or passage is in communication with the inner passage of said flexible hollow telescopic connector.

8. The tire calibration arrangement according to claim 7, characterized in that said rotor comprises:
a block rotatably mounted on said rotor axle by means of respective ball bearings;
a connector within which an end of said flexible hollow telescopic connector is provided, wherein the latter is kept held among said connector, said rotor axle, and a locking washer; and
a solid seal arranged in the interior of said block and which is kept held by means of a set of guide, O-ring and spring, said cylindrical head provided with an inner passage in communication with the inner passage of said rotor axle, and, in turn, said inner passage of the cylindrical head is in communication with a transfer chamber that is operatively communicated said respective tire inflation and/or deflation valves.
